(19) United States
(12) Patent Application Publication
(10) Pub. No.: US 2021/0331309 A1
(43) Pub. Date: Oct. 28, 2021

(54) ROBOTIC SYSTEM, COMPRISING AN ARTICULATED ARM

(71) Applicant: UNIVERSITÉ LE HAVRE NORMANDIE, Le Havre (FR)

(72) Inventor: Jean-François Brethe, Sainneville (FR)

(73) Assignee: UNIVERSITÉ LE HAVRE NORMANDIE, Le Havre (FR)

(21) Appl. No.: 17/281,070

(22) PCT Filed: Sep. 26, 2019
(86) PCT No.: PCT/FR2019/052285

§ 371 Date: Mar. 29, 2021

(30) Foreign Application Priority Data
Oct. 1, 2018 (FR) 1859074

(51) Int. Cl. B25J 9/10; B25J 9/02

(52) U.S. Cl. CPC B25J 9/107; B25J 15/00; B25J 9/023

(57) ABSTRACT

Robotic systems include an articulated arm having a deformable assembly consisting of having a plurality of bars connected by parallel pivot axes to form at least one deformable structure, the distal end of the deformable assembly supporting a mechanical interface, the system further including two actuators which rotate two of the bars, and a third actuator controlling the translational movement of the deformable assembly in a direction parallel to the pivot axes.

### FIELD OF THE INVENTION

The present invention relates to the field of robotic arms, for gripping and movement of items, the handling of a tool for manufacturing tasks, in restricted spaces, for example in deep racks or shelves leaving little space between the superficial layer of items and a shelf or a surface situated above the item container.

It relates to object gripping applications in particular, but not exclusively, logistics and warehouses or storage racks or racks for storing industrial components or palettising/depalettising, etc.

It is reminded that a warehouse is a logistics building intended for the storage of products before their shipping to a client. The main processes implemented within a warehouse are receiving orders, stocking up, preparing orders, shipping and managing stock. Generally, the invention relates to situations where products must be recovered and placed in another point, with an available space which can be very restricted or constrained, both in height and in width, and where the depth can, on the contrary, be significant.

For logistics applications, the incoming flows of a warehouse generally consist of goods delivered on pallets by lorries putting them on a platform.

Operators unload the pallets from the lorries, then store them on racks where they will be on standby. The outgoing flows consist of homogenous pallets (one single reference per pallet) or heterogenic pallets in which different types of referenced products are aggregated. Thus, the different products must be recovered, an operation termed “picking”, from pallets in use generally disposed in a place on the ground under a rack. When the pallet is empty, a resupplying request is launched and an operator manoeuvres a forklift to recover a pallet at height and place it in the place on the ground under a rack.

The present invention more specifically relates to an assembly comprising a station for preparing orders (also termed “picking station”), in particular but not exclusively in the case where this forms part of an automated storage system comprising a storage rack and one or more stations for preparing orders.

The present invention can be applied to all types of order preparation, and in particular:
the preparation of orders by sampling products in storage containers: an operator (or an automaton, i.e. a robot) receives a list of items (on paper, on screen of a terminal or also in voice form) indicating to them, for each parcel to be shipped (also termed shipping container), the quantity of each type of product that they must collect in shipping containers and group them together in the parcel to be shipped; and
the preparation of orders by palettising storage containers themselves containing products: an operator (or an automaton) receives a list of items (on paper, on screen of a terminal, in voice form, or also in the form of a computerised task in the case of the automaton) indicating to them, for each pallet to be shipped (also termed shipping container), the quantity of each type of storage container (for example, boxes) that they must collect and unload on the pallet to be shipped.

Generally, two types of stations for preparing orders are distinguished: moving stations and fixed stations.

The moving stations implement the “man to goods” principle, according to which the preparer is moved to the place of sampling and takes the number of products ordered there.

The fixed stations implement the “goods to man” principle, according to which the storage containers (for example, boxes or plates), each containing products of a given type, are automatically taken out of a storage magazine (on transfer devices termed carriages or shuttles) and arrive in front of or in the proximity of the preparer who must take, the number of products ordered from each.

This distinction between moving stations and fixed stations also applies in the case of palettisation: either the preparer is moved to go and look for the storage containers to be unloaded on the pallet to be shipped, or these storage containers are automatically brought to the preparer (for example, by an automated storage and retrieval system).

The present invention can be used just as well in the case of a fixed station for preparing orders when the frame of the robotic arm is fixed to the ground, as in the case of a moving station when the main frame of the robotic arm is fixed on a carriage or mobile robot.

In the present description, by elevator, is meant any system for taking one or more loads (storage or shipping container(s)) to a given level and to deposit it/them at another level.

Storage warehouses are generally structured by rows of racks where items are stored.

The lower row of racks on the ground is intended for the removal of the items according to the order of management. This operation termed “picking” is done manually, or more and more by using a robotic arm mounted on a mobile carriage.

The invention also relates to other fields of application, such as the movement of a tool for manufacturing tasks in restricted spaces where the introduction and the positioning of the tool do not allow a large amplitude of movements in one of the directions, while requiring a larger amplitude of movements in the plane perpendicular to the limited direction. This is, for example, an intervention between two surfaces, for example on the lower surface of the chassis of a vehicle placed on the ground, an intervention between two plates close to one another, etc.

Manufacturing tasks are, for example, painting, screwing, welding, trimming, riveting, machining, 3D printing (additive manufacture), etching, laser cutting, electro-erosion, etc.

### TECHNOLOGICAL BACKGROUND

A mobile robot is known from the state of the art of patent application WO2018086748 describing a robotic arm, comprising an undercarriage and a robotic arm mounted on the undercarriage, as well as a logistical system comprising a goods support, which is designed for the transitional storage of goods, and comprising a self-guided vehicle, which is designed to transport the goods support, as well as a corresponding mobile robot.

Chinese patent application CN106112952A discloses a robotic loading and transfer double-arm intended for the rapid loading of parcels during air transport. The robotic arm comprises a clamping module composed of mechanical arms, a disk mechanism and a guide rail mechanism and a conveyor belt module used for the transfer.

### DISADVANTAGES OF THE PRIOR ART

The solutions of the prior art have different disadvantages.

First, the robotic arm must be capable of operating in an often very restricted space: the height between the top of the container or item to be gripped and the following shelf can be only a few centimetres. The arm must also be able to be positioned laterally between stacks of items of unequal heights, limiting the lateral articulation.

Moreover, the series type robotic arms generally require motorised articulations, extending over the length of the arm. This is conveyed by a significant mobile mass, involving a robust and bulky architecture.

Finally, most of the series type holding arms carry generally quite low useful loads with respect to their total moving mass. As the loads to be transported can be relatively significant, of a few tens of kilograms, this involves using powerful and heavy motors, and leads to a significant energy cost.

### SOLUTION PROVIDED BY THE INVENTION

In order to overcome these disadvantages, the invention relates to, according to its most general sense, a robotic system, comprising an articulated arm, characterised in that said articulated arm has a deformable assembly consisting of a plurality of bars connected by parallel pivot axes to form at least one deformable structure, the distal end of said deformable assembly supporting a mechanical interface, said system further comprising two actuators which rotate two of said bars, said system further comprising a third actuator controlling the translational movement of said deformable assembly in a direction parallel to said pivot axes.

By “mechanical interface”, is meant, in the sense of the present patent, a means moved by the robotic system and provided for the coupling of a tool such as a clamp or a gripping mechanism of an object to be moved, or a tool to carry out manufacturing operations.

By “bar”, is meant, in the sense of the present patent, a long and rigid part, of low thickness with respect to its length, of any transversal cross-section.

The deformable assembly consists of deformable quadrilaterals which are preferably deformable parallelograms and even more preferably, deformable diamonds.

According to variants of embodiments, independent or combined together, the invention is also characterised by the following features:
said articulated arm has a deformable assembly consisting of a plurality of bars connected by parallel pivot axes to form at least one deformable structure, the distal end of said deformable assembly supporting a mechanical interface, the proximal end of said deformable assembly consisting of two proximal bars of which the angular positions are controlled by two actuators, said proximal end being able to be translationally moved in a direction parallel to said pivot axes thanks to a third actuator;
said deformable assembly consists of at least two consecutive deformable parallelograms sharing common bars;
said deformable assembly consists of two deformable diamonds sharing common bars, connected by a central pivot and consisting of six bars assembled by pivot connections of axis z perpendicular to the plane defined by said bars;
said deformable assembly consists of an assembly of N deformable diamonds sharing common bars, connected by central pivots and consisting of 2N+2 bars assembled by pivot connections of axis z;
said proximal bars are controlled by three actuators all situated on a main frame;
said robotic system comprises at least one intermediate frame and said proximal bars are controlled by actuators all situated on a main frame;
the height of the robotic arm along the axis z perpendicular to the plane of said deformable assembly is adjusted by a plate actuated by a threaded rod driven by a first actuator;
said first proximal bar is driven by an actuator by way of a shaft and said second proximal bar is driven angularly by another actuator by way of a series of hollow shafts which could slide freely against one another;
said first proximal bar is driven by an actuator by way of a shaft and said second proximal bar is driven angularly by another actuator by way of a second shaft and a system of sliding toothed pinions or sliding toothed belts;
a first actuator is fixed on the main frame and ensures the control of the orientation of a first intermediate frame, a motorised slide connection placed on the first intermediate frame ensuring the placement along an axis z, perpendicular to the plane defined by said deformable assembly, a second intermediate frame supporting the proximal end of said deformable assembly, a third actuator fixed on the second intermediate frame or on the first intermediate frame or on the main frame controlling the orientation of the proximal bar by way of a shaft, the proximal bar remaining fixed with respect to the second intermediate frame;
a first actuator is fixed on the main frame and ensures the control of the orientation of an intermediate frame by way of a shaft, and consequently ensures the control in orientation of one of the two proximal bars, a second actuator fixed on the main frame or on the intermediate frame controlling the orientation of the second proximal bar by way of a shaft;
the proximal bars of said deformable assembly are assembled on an intermediate frame controlled in translation along z thanks to a slide connection and a first actuator, the orientations of said proximal bars being controlled by two actuators fixed on the main frame or on the intermediate frame;
the proximal bars of said deformable assembly are assembled on an intermediate frame controlled in translation thanks to a slide connection and a first actuator, the orientations of said proximal bars being controlled by two actuators fixed on the intermediate frame;
said deformable assembly is formed of bars connected by pivot axes, the relative distance between the proximal articulations of said deformable assembly being controlled by an actuator, the orientation of said deformable assembly in a plane perpendicular to said pivot axes being dependent of an intermediate frame the orientation of which is controlled by an actuator;
said articulated bars have a deformable assembly formed of bars connected by pivot axes, the distal end of said deformable assembly supporting a gripping member or a tool, the proximal end of said deformable assembly consisting of two bars the proximal axes of rotation of which are parallel and are not coincident and the angular positions of which are controlled by two actuators;
the distal end of the robotic arm comprises a motor and a pivot connection along an axis z and supporting a gripping means or a tool;
the distal end of the robotic arm comprises a wrist comprising at least one motorised articulation, and supporting a mechanical interface such as a gripping means or a tool;
the distal end of the robotic arm comprises a motor allowing control of the orientation of an additional arm articulated along an axis z and supporting a mechanical interface;
the robotic system comprises a main frame assembled on a carriage or a mobile robot;
the robotic system comprises a main frame fixed to the ground.

### DETAILED DESCRIPTION OF NON-LIMITING EXAMPLES OF THE INVENTION

The present invention will be better understood upon reading the following description, referring to the appended drawings illustrating non-limiting examples of implementations, where:

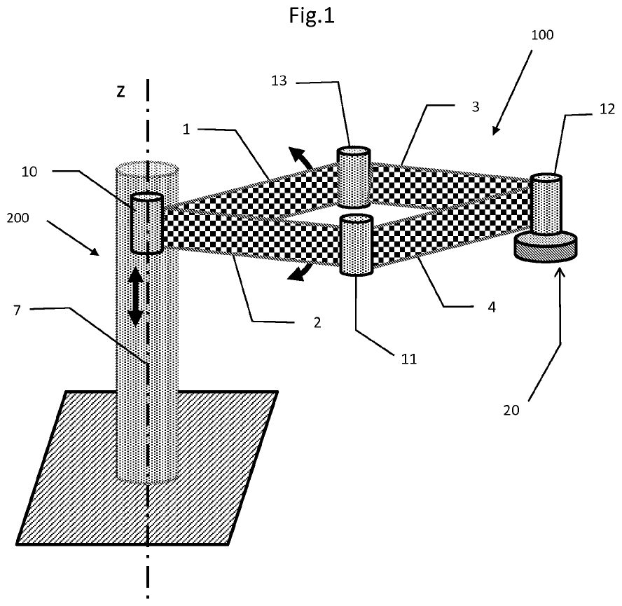

FIG. 1 represents a schematic, perspective view of a first embodiment variant of the invention,

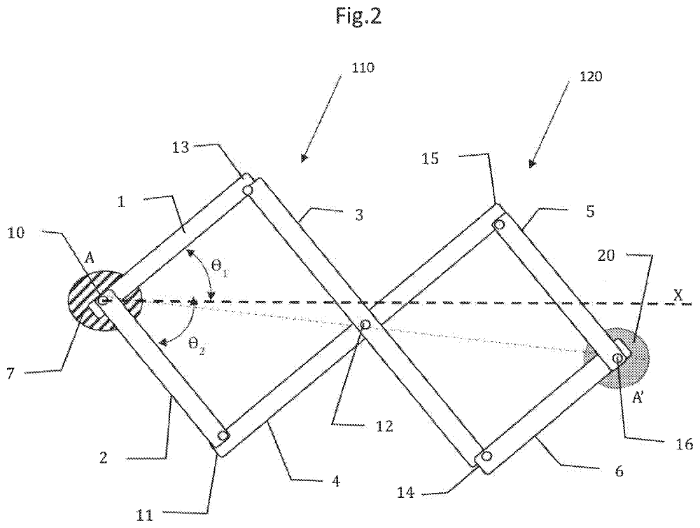

FIG. 2 represents a schematic top view of a second variant of the invention comprising two deformable diamonds sharing common bars,

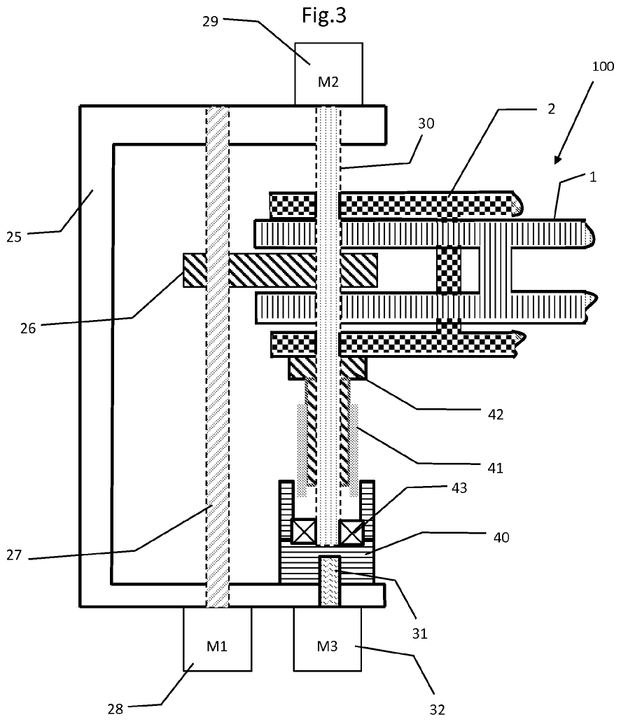

FIG. 3 represents a schematic view of a third embodiment variant of the invention, with a mechanism for driving the robotic arm implementing three geared motors fixed on the same frame, the two geared motors actuating the deformable assembly being situated on the same axis,

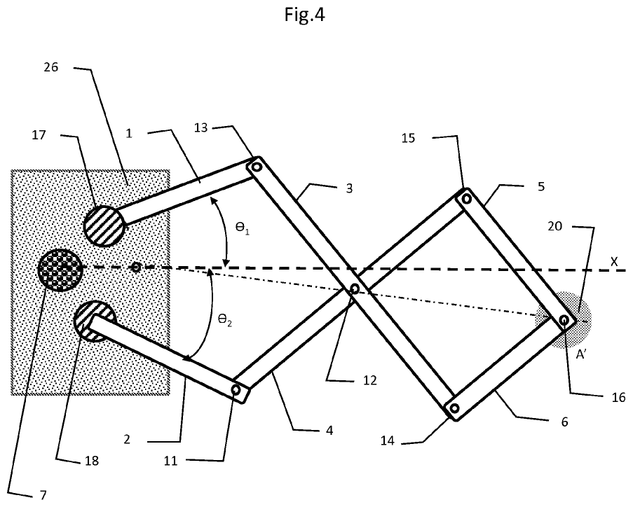

FIG. 4 represents a schematic view of an alternative variant of the kinetics of the robotic arm according to the invention where the axes of the articulations of the proximal ends of the deformable assembly are no longer coaxial,

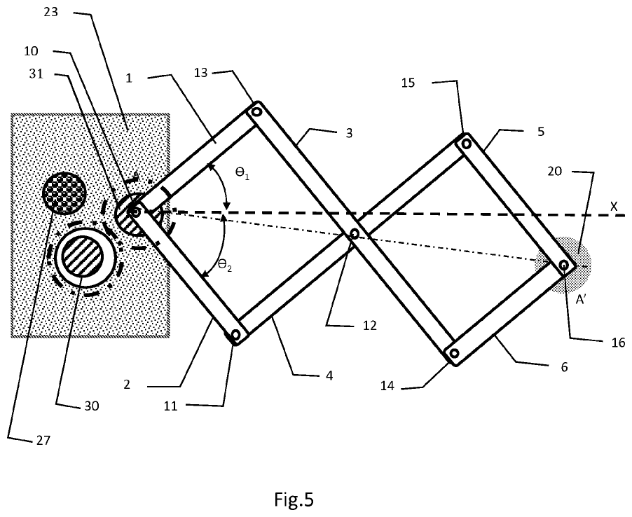

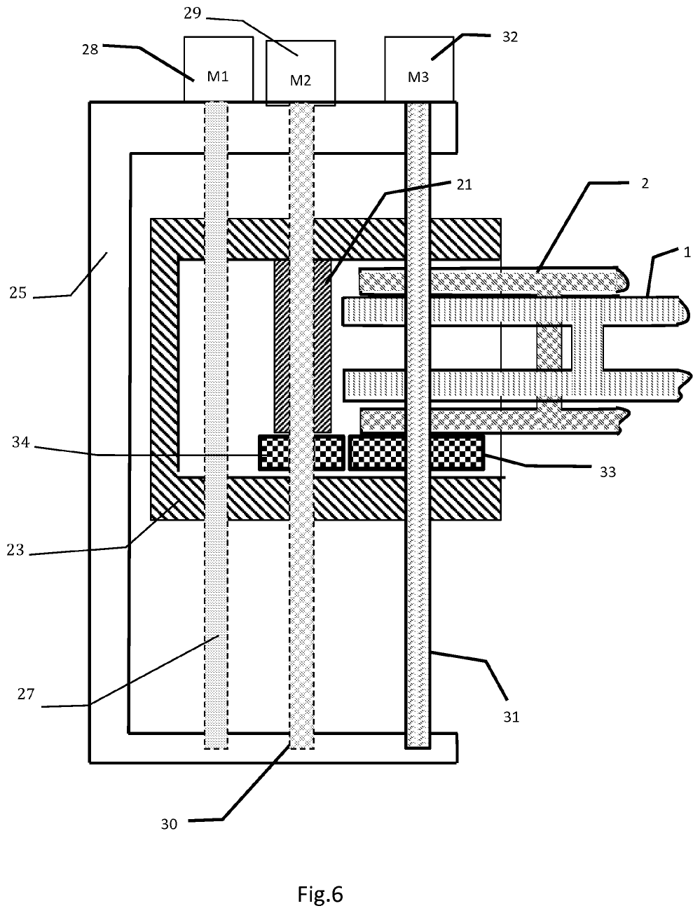

FIGS. 5 and 6 represent two schematic views of a second embodiment variant of the drive mechanism of the robotic arm according to the invention,

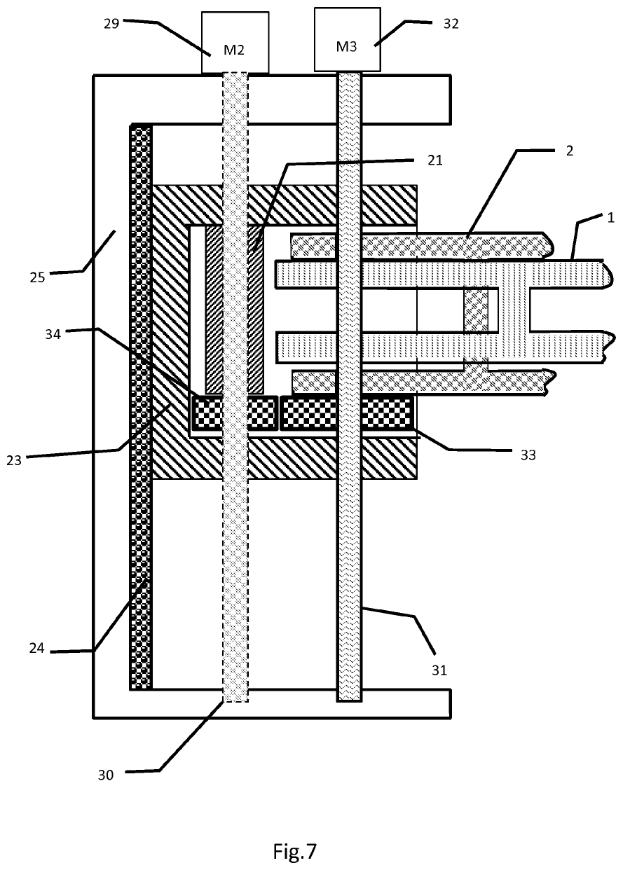

FIG. 7 represents a schematic view of a third embodiment variant of the drive mechanism of the robotic arm according to the invention,

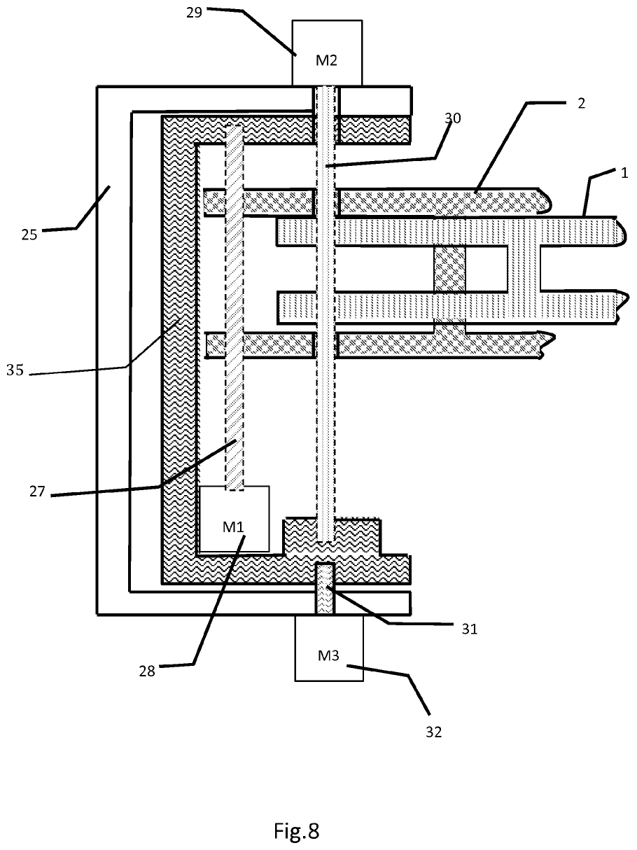

FIG. 8 represents a schematic view of a fourth embodiment variant of the drive mechanism of the robotic arm according to the invention,

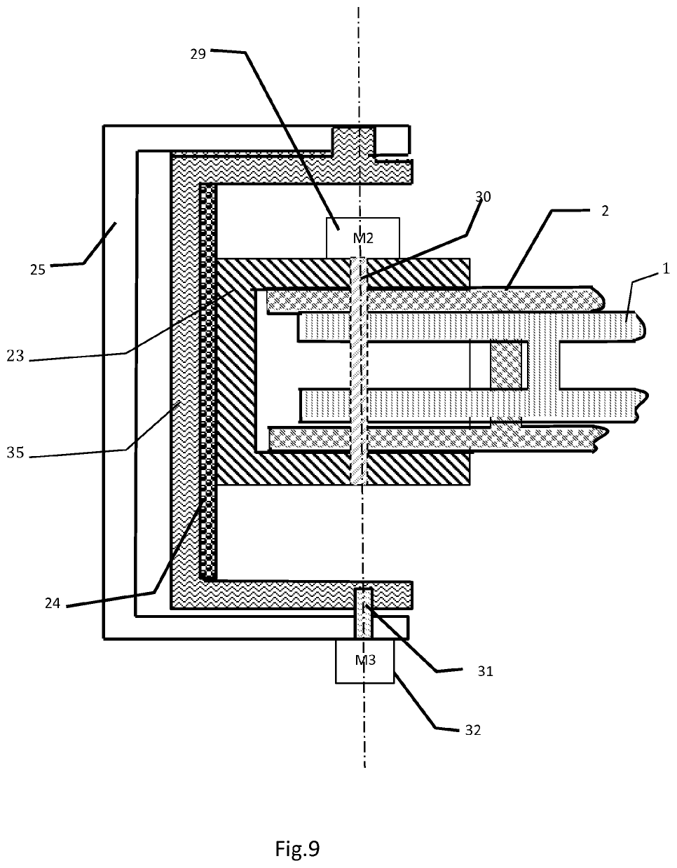

FIG. 9 represents a schematic view of a fifth embodiment variant of the drive mechanism of the deformable assembly according to the invention,

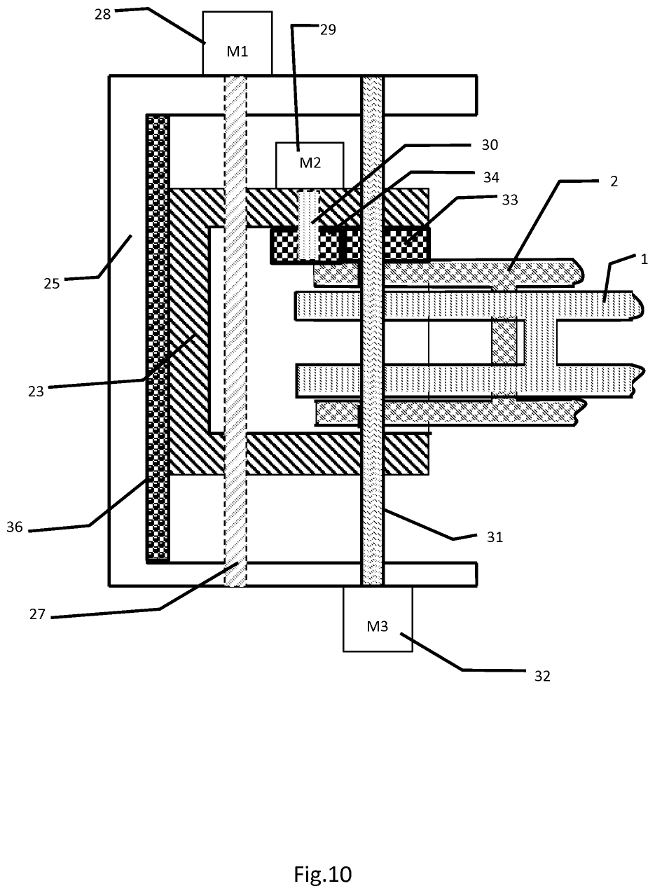

FIG. 10 represents a schematic view of a sixth embodiment variant of the drive mechanism of the robotic arm according to the invention,

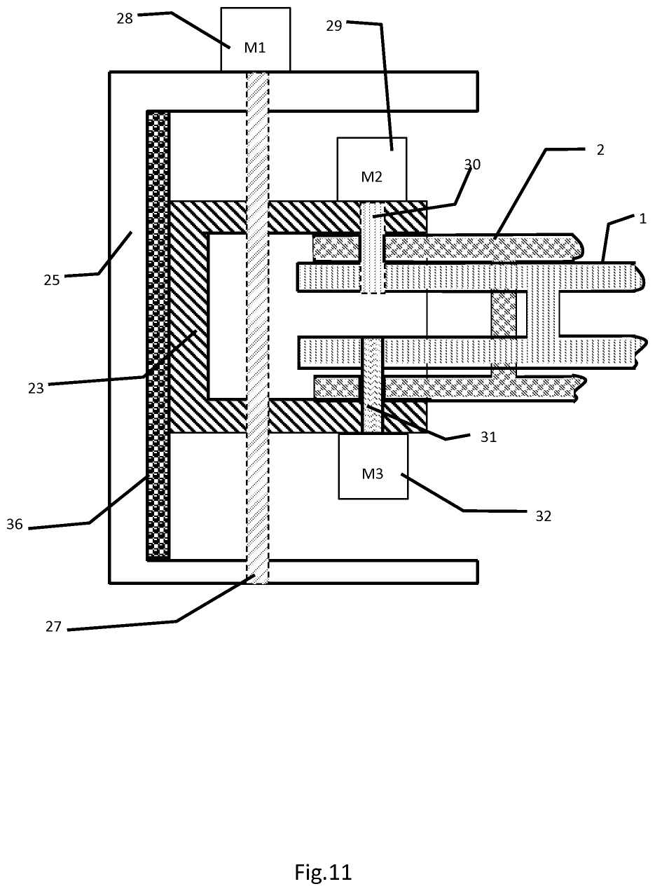

FIG. 11 represents a schematic view of a seventh embodiment variant of the drive mechanism of the robotic arm according to the invention,

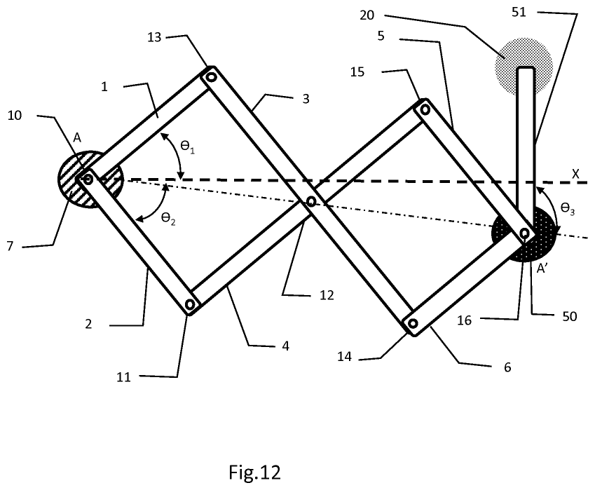

FIG. 12 represents a schematic view of the kinetics of the invention when an additional arm is added to the distal end, controlled by a geared motor and supporting at its distal end, a gripping means or a tool,

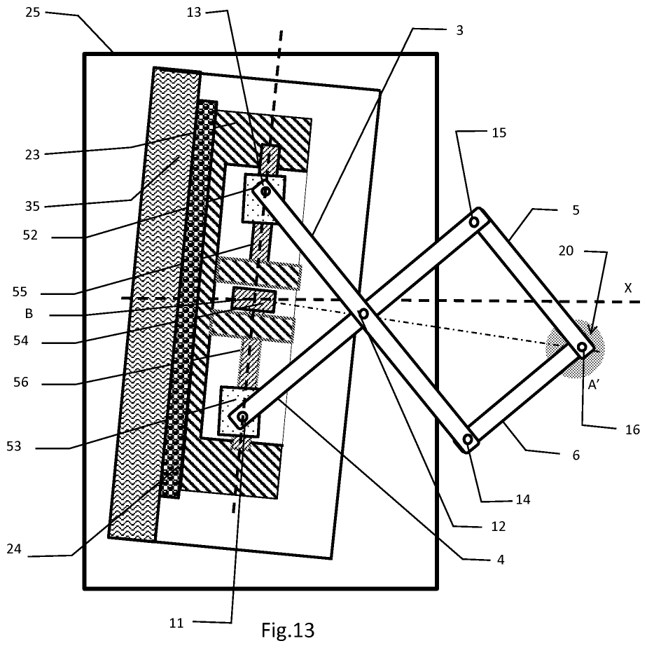

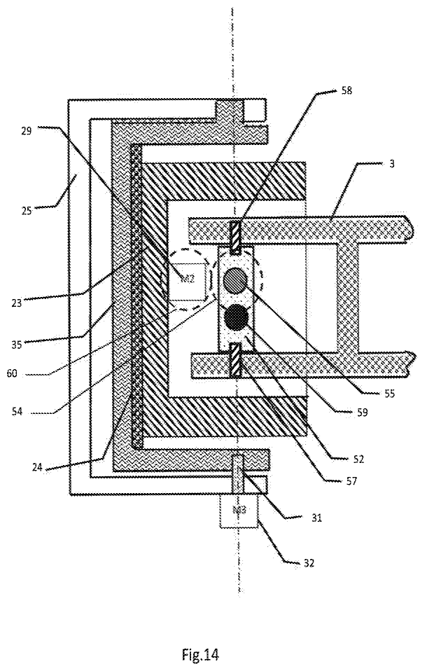

FIGS. 13 and 14 represent a schematic view of the kinetics of a particular variant of the invention.

### BACKGROUND OF THE INVENTION

The robotic manipulator according to the invention has 3 degrees of freedom, with:
a movement in the plane of an arm (100) formed by a deformable articulated assembly having at its distal end, a mechanical interface such as a tool or a gripper (20),
a movement, in particular along an axis perpendicular to the arm (100), with respect to a support (200).

The robotic manipulator according to the invention has an architecture offering the following advantages:
it can remove significant loads,
it consumes very little energy, in particular it consumes practically no energy in holding a heavy object when the vertical translation is provided by an irreversible screw/nut system, the manipulator thus not needing a brake to ensure the safety of the manipulator. The arm is indeed in particular intended to carry significant loads which falling could constitute a risk for users, which requires a brake in a manipulator according to the prior art,
at least two (1, 2) bars, preferably all the bars, of the plurality of bars (1 to 4), can each consist of an assembly of two profiles connected by a spacer; this decreases the production cost and optimises the use of the material,
two profiles of a bar (1) can be surrounded, in the direction parallel to the pivot axes, by two profiles of another bar (2); this new mechanical design makes it possible to limit the deformation of the flat deformable mechanism due to the bending forces when it is subjected to a significant vertical load at its distal end, as well as decreasing the lengths of the pivot connection supports of the proximal bars thanks to the significant space between the two supports of each of the bars obtained due to this mechanical design; the bracing phenomena are thus controlled and the reaction forces on each of the supports are much lower than in the prior art for an equivalent useful load;
a U-shaped main frame, of which each of the lateral branches picks up (directly or indirectly) the forces of the parallel pivot axes; this ensures better rigidity, which makes it possible to move the intermediate frame, or directly the mechanical interface, by obtaining much more precision for the distal end, as with an equivalent vertical load on the distal end, the deformations of the intermediate frame resulting from the bending forces on the vertical slide connection are less than in a manipulator according to the prior art,
a main frame and at least two of said actuators are disposed on said main frame; the dynamic performance of the manipulator is thus improved; when the main frame supports at least two actuators, the “useful mass”/“moving mass” ratio is much more favourable than that according to the prior art;
the zones reachable by the end of the arm (100) in a working plane are significant compared with usual anthropomorphic robotic arms,
the bulk is reduced when the arm (100) is folded,
controlling the device is simple and the inverse geometric model can be analytically resolved.

In particular, this device is very advantageous for carrying out palettising/depalettising operations, due to the fact that its working space is extended and that it can be deployed in zones with a reduced free space to carry out the pick and place tasks.

In particular, the arm is very advantageous for carrying out “pick and place” operations needing to be performed from a mobile robot due to a large working space, its handling and the low energy consumption.

This device according to the invention is also particularly suitable for movement in a restricted space of a tool fixed to the distal end of the arm (100), for interventions in difficult contexts, for example with a low available height and the need for a positioning of the tool precisely and reproducibly on a significant surface.

The tool supported by the arm (100) can be a spray nozzle for painting applications, an additive printhead, or a machining or assembling tool.

Simplified Examples

FIG. 1 represents a schematic view of the kinetics of the invention with a pantograph-shaped articulated arm (100) limited to a deformable quadrilateral.

The pantograph consists of four rigid bodies or “bars” (1 to 4) connected by pivot articulations (10 to 13) perpendicular to said plane defined by the pantograph, to form a deformable flat quadrilateral.

In the present description, “pantograph” means an articulated assembly of bars defining a succession of deformable flat quadrilaterals or an assembly of consecutive coplanar deformable quadrilaterals assembled by pivot connections of axis perpendicular to said plane. In the latter case, two consecutive quadrilaterals have a common peak and share two common bars pivoting with respect to this common peak.

By “proximal”, means the portion of the arm (100) closest to the support (200) and by “distal” or “terminal”, is meant the portion the farthest away, where the mechanical interface (20) is located, of which the movement is controlled.

The three pivot articulations (11 to 13) are passive and the pivot articulation (10) is motorised and integrates two actuators independently controlling the angular movement of each of the proximal bars respectively (1, 2). The proximal end of the deformable quadrilateral is translationally moved along the axis (7) perpendicular to the plane allowing the positioning of the distal end of the deformable quadrilateral at height, along the axis z. The arm (100) has, at its distal end, a gripping means (20), for example a suction cup or a tool.

The two proximal bars (1, 2) are independently rotated by actuators. In the present description, “actuator” means a device ensuring a movement, generally angularly less than 360°, controlled by an electric signal transmitted by wire or by radiofrequency.

In a non-limiting manner, a rotating or linear electric motor will be considered as an actuator in the sense of the present patent, in particular of the electromagnetic, hydraulic, pneumatic, piezoelectric type, an electromagnetic actuator, a geared motor.

When the quadrilateral forms a diamond and when the two bars (1, 2) are moved by one same angle, in opposite directions, the distal end (20) is moved over a rectilinear trajectory connecting the intersection point of the axes (10) and (12) with the horizontal plane which makes it possible to position the gripping means (20) above the item to be gripped.

When the movement angle of a proximal bar (1) differs from the movement angle of the other proximal bar (2), the distal end (20) is moved according to a curved movement with a lateral component.

It is thus possible to scan a working surface with the gripping means or with the tool by adjusting the angles of the proximal bars (1, 2) in a reduced space and at a low height.

FIG. 2 represents a schematic view of the kinetics of the invention where the pantograph comprises two adjacent deformable quadrilaterals (110, 120), in this case diamonds, connected by a central pivot (12) of axis z. The kinetic chain consists of six bars (1 to 6) assembled by pivot connections of axis z; the bars (1, 2, 5, 6) are of the same length L; the bars (3 and 4) common to the two deformable quadrilaterals (110, 120) are of length 2L.

The assembly is deformed according to two identical diamonds, the deformation being controlled by mechanical control of the angles 61 and 82 that the bars (1) and (2) make with respect to the longitudinal axis X of the main frame.

Of course, the number of quadrilateral units of the pantograph can be increased.

In an alternative version of the flat mechanism, the folding of the kinetic chain of the pantograph can be obtained by associating a rotation mechanism on the axis (7) and a translation mechanism inserted between any two points of the kinetic chain of the pantograph carefully selected for example by control of the distance between the pivots (11, 13) obtained by motor mechanism and screw and screw/nut system. It is possible even to remove the two proximal bars (1 and 2), as will be detailed in a subsequent variant.

Operation of the invention The robotic manipulator arm consists of a kinetic chain and a control system.

The kinetic chain ensures two functionalities:

1) positioning of a mechanical interface according to the 3 degrees of freedom of the space in translation referenced xyz;

2) orientation of a mechanical interface according to the 3 degrees of freedom of the space in rotation for the objects when a motorised wrist supporting this mechanical interface is added to the end of the kinetic chain.

By mechanical interface, is meant a tool, a wrist, a gripper or an effector.

The first functionality is obtained using the following principles:

a) the translation along an axis z of a flat pantograph-type mechanism allowing positioning in z, the distal end of the kinetic chain;

b) a flat pantograph-type mechanism allowing positioning in the plane xy, the terminal end, thanks to the control in rotation of the two first bars 1 and 2 and a kinetic chain consisting of 4 bars in its simplest version, of 6 bars in its usual version and 2 N bars in more developed versions.

Embodiment Variant

FIG. 3 represents an embodiment variant where the two bars (1, 2) are controlled by two motors (29, 32) positioned on the same frame (25). This frame (25) is termed main frame or fixed frame. It can be fixed to the ground or fixed on a carriage or mobile robot.

The height of the arm (100) is adjusted by a plate (26) actuated by a threaded rod (27) driven by a first geared motor (28) thanks to a screw/nut mechanism. Due to the fact that the plate (26) slides freely on the shaft (30) and is constrained by the threaded rod (27), its orientation in the plane xy is constant and provides a longitudinal axis.

The first bar (1) is driven by a second geared motor (29) by way of a shaft (30). In the example described, this shaft (30) is integral with the first bar (1) to drive its angular movement with respect to the reference point attached to the frame (25). The support of the arm (100) can slide along the shaft (30) by slide connection (30) due to the fact that the mechanical connection is constrained by a slot or a pin/groove device or by using a non-circular cross-section for the shaft (30) or any other equivalent device. The shaft (30) extends to the slotted flange (40), ensuring the positioning of the end of the plate (26), supports the second bar (2) and a set of hollow shafts (41 to 42), free to freely slide on this shaft (30).

The second bar (2) is driven angularly by a third geared motor (32) by way of a second shaft (31). This second shaft (31) is integral in rotation with the bar (2) thanks to a series of hollow shafts (40 to 42) free to slide axially between them in the limit of a maximum axial articulation limited by an abutment system, the relative rotations of said hollow shafts being prevented by pin/groove systems, slots, the use of non-circular cross-sections or other equivalent devices allowing translation without rotation. The last hollow shaft (42) is fixed on the second bar (2) by screws or other equivalent mechanical device. The sum of the cumulative axial articulations of the different hollow shafts is calculated such that the terminal end (20) can be moved on the vertical axis according to the desired distance.

Embodiment Variant with Two Non-Coaxial Proximal Axes of Rotation

FIG. 4 represents a schematic view of an alternative variant of the kinetics of the robotic arm according to the invention where the proximal actuation axes of the flat mechanism are no longer coaxial.

The geared motor (29) rotates the shaft (17). The bar (1) is integral in rotation with the shaft (17) which is a slotted or grooved shaft.

The geared motor (32) rotates the shaft (18). The bar (2) is integral in rotation with the shaft (18) which is a slotted or grooved shaft.

The geared motor (28) rotates the shaft (7) by way, for example, of a screw/nut system, causing a vertical movement of the plate (26). The plate (26) can slide freely in translation with respect to the shafts (17) and (18) without being constrained in rotation with respect to these two shafts. In this variant, the mechanical implementation is simplified and does not require the assembly of hollow shafts. However, the direct and inverse geometric models which link the articular coordinates θ₁, θ₂, z and the operational coordinates x, y, z of the robot are more difficult to obtain, and the working space is reduced with respect to the first variant.

Embodiment Variant Comprising a Torque Transmission on One of the Arms by Way of Toothed Pinions

FIGS. 5 and 6 represent two schematic views of a second embodiment variant of the drive mechanism of the robotic arm according to the invention comprising three geared motors (28, 29, 32) fixed on the same frame (25). An intermediate frame (23) is driven in translation along z thanks to the geared motor (28) actuating a screw/nut system. This intermediate frame (23) is also termed mobile frame. The two geared motors (29) and (32) actuating the proximal bars (1, 2) of the pantograph are situated on two different axes, the two active pivot connections of the pantograph remaining coaxial thanks to the pinion system (33, 34) proposed. The proximal bar (1) is controlled by the geared motor (32) by way of a slotted shaft (31), while the proximal bar (2) is controlled by the geared motor (29) by way of the slotted shaft (30) and of two toothed pinions (33, 34). The proximal bar (2) slides freely in translation and rotation on the axis (31). The toothed pinion (34) slides freely in translation along the slotted shaft (30) while being constrained in rotation with respect to this shaft. The toothed pinion (33) slides along the slotted shaft (31) without being constrained in rotation with respect to this shaft; the pinion (33) is integral with the proximal bar (2) by a mechanical fixing of screw type or equivalent. The spacer (21) constrains the positioning of the pinion (34) at the same height that the pinion (33) allowing a permanent contacting of the teeth. The intermediate frame (23) slides freely in translation and rotation on the shafts (30) and (31); its inner width ensures the coherence of the placement of the mechanical elements (arms, pinions, spacer, etc.) The threaded shaft (27) controlled by the geared motor (28) makes it possible to ensure the vertical movement of the plate by screw/nut system.

FIG. 7 represents a schematic view of a third embodiment variant of the drive mechanism of the robotic arm according to the invention where the intermediate frame (23) driving the pantograph along z is translationally moved thanks to a slide connection and a linear motor (24) integral with the fixed frame (25).

The bar (1) is controlled by the geared motor (32) by way of a slotted shaft (31), while the bar (2) is controlled by the geared motor (29) by way of the slotted shaft (30) and two toothed pinions (33, 34).

Variants Comprising an Intermediate Frame Controlled in Rotation from the Fixed Frame

FIG. 8 represents a schematic view of a fourth embodiment variant of the drive mechanism of the robotic arm according to the invention, where an intermediate frame (35) is rotationally moved and the two geared motors (29) and (32) actuating the pantograph are situated on the main frame (25).

The geared motor (28) is integral with the intermediate frame (35) and allows through its associated threaded shaft (27), control of the position along z of the assembly of the bars (1) and (2) thanks to a screw/nut system between the bar (2) and the threaded shaft (27). The shafts (27) and (30) allow blocking the rotation of the bar (2) with respect to the intermediate frame (35) and the orientation of the bar (2) is thus controlled by the geared motor (32) due to the fact that the shafts (30) and (31) are coaxial. The shafts (30) and (31) can however, in certain variants, not be coaxial, but their axes remain parallel.

The geared motor (32) is fixed on the fixed frame (25) and ensures the control in orientation of the intermediate frame (35) thanks to the securing of its output shaft (31) to the frame (35).

The geared motor (29) integral with the fixed frame (25) makes it possible to control the absolute orientation of the bar (1) by way of the slotted or grooved shaft (30). In certain variants, this geared motor (29) which can be integral with the intermediate frame (35) allowing control of the relative orientation of the bar (1) with respect to the bar (2).

FIG. 9 has a schematic view of a fifth embodiment variant of the drive mechanism of the robotic arm according to the invention.

A first actuator (32) controls the orientation of the first intermediate frame (35) pivoting along the axis z with respect to the main frame (25). This first intermediate frame (35) is rotationally moved, removing a second frame (23). This second frame (23) is translationally moved with respect to the first intermediate frame (35) by way of a slide connection by way of a linear motor (24). It removes a geared motor (29) allowing control of the relative orientations of the two proximal bars (1, 2) of the pantograph.

The geared motor (29) fixed on the frame (23) makes it possible to control the relative orientation of the bar (1) with respect to the bar (2) thanks to the shaft (30) integral with the proximal bar (1), the proximal bar (2) being fixed with respect to the frame (23). The geared motor (32) controls in rotation the intermediate frame (35) by way of the shaft (31). The translational movement of the intermediate frame (23) can also be controlled by a screw/nut system, shaft (27) and geared motor (28) according to the same principle as FIG. 8.

According to a variant (not represented) of the embodiment of the fifth variant, only described for its differences with said variant, an embodiment is provided wherein the second actuator (29) is fixed on the first intermediate frame (35) or on the main frame (25).

Generally, the screw/nut system proposed in the preceding variants is interesting from a safety standpoint as due to the irreversibility of the screw/nut system, it avoids having to implement mechanical brakes in the case where the motors would no longer be supplied with energy. Such an eventuality must be considered with caution as the arm is intended to remove significant loads, of which them falling could constitute a risk for users or the products to be moved, or the mechanical system itself.

However, another ball screw type translation system, or linear motor on slide connection can be implemented to manage the translation of the arms along z.

The favoured direction of installation of this manipulator robot is that the direction z corresponds to the vertical axis.

Thus, during the movement of heavy loads in a horizontal movement, the geared motor (28) is not requested and the geared motors (29, 32) only support low torques with respect to the torques supported by anthropomorphic type robots carrying out the same trajectory. The energy consumption is highly reduced.

The mechanical structure is designed to support significant static and dynamic forces generated during tasks of picking/placing objects of high masses.

The moments of inertia of the cross-sections of the bars (1, 2) are calculated so as to be able to support significant loads, in particular the geometry of the arms such as described schematically in FIG. 9 allows an optimal sizing. This structure of the bars (1, 2) uses standard components formed, for example, by two profiles connected periodically by spacers and makes it possible to obtain, by assembly, a high resistance to the bending and the torsion of the complete mechanism.

Embodiment Variants Comprising an Intermediate Frame Controlled in Translation with Respect to the Fixed Frame

FIG. 10 represents a schematic view of a sixth embodiment variant of the drive mechanism of the robotic arm according to the invention.

The proximal bars of the pantograph (1, 2) are articulated from an intermediate frame (23).

The intermediate frame (23) driving the pantograph along z is translationally moved thanks to a slide connection (36) and a screw/nut type drive, a geared motor (32) fixed on the main frame (25) allowing control of the first proximal bar (1) of the pantograph by way of the slotted shaft (31), while a second geared motor (29) embedded on the intermediate frame (23) makes it possible to control the second bar (2) of the pantograph by way of a shaft (30) thanks to a system of gears (33) and (34).

The threaded shaft (27) driven by the geared motor (28) ensures a translational guiding along z of the frame (23) by screw/nut system.

The toothed pinion system (33) and (34) can possibly be replaced by equivalent belt, notched belt or other type systems, intended to transmit a rotational movement between two non-coaxial shafts. According to a variant (not represented) of the embodiment of the sixth variant, only described for its differences with said variant, an embodiment is provided wherein the second actuator (29) is fixed on the main frame (25).

FIG. 11 represents a schematic view of a seventh embodiment variant of the drive mechanism of the robotic arm according to the invention where the intermediate frame (23) driving the pantograph along z is translationally moved thanks to a slide connection and a screw/nut type drive, via the threaded shaft (27) and the geared motor (28). Two geared motors (29, 32) fixed on the intermediate frame (23) allow control of the orientation of the two proximal arms of the pantograph thanks to the slotted shafts (30) and (31) of which the axes are coaxial.

The geared motor (29) controls the orientation of the bar (1) thanks to the slotted shaft (30) while the geared motor (32) controls the orientation of the bar (2) thanks to the slotted shaft (31). The bar (1) is moved freely in rotation with respect to the shaft (31) while the bar (2) is moved freely in rotation with respect to the shaft (30).

It is also possible that the output shafts of the geared motors are not coaxial and that the transmission of the rotational movement is obtained by way of a toothed pinion system or equivalent.

In this variant, it can be considered that the slide connection driving the intermediate frame is made in a direction different from z, for example parallel to the plane of the pantograph. Vertical mobility can also be added to the distal end.

Use of the Robotic Arm to Carry Out Works in an Congested Environment

FIG. 12 represents a schematic view of the kinetics of the invention when an additional arm (51) is added to the distal end, controlled by a geared motor (50) and supporting at its distal end, a gripping means or a tool (20).

In this case, the rotation of the latter segment makes it possible to work in very narrow and constrained spaces, both in height and in width.

In the case where the gripper or the tool is fixed directly on the geared motor (50), the terminal end (or the object gripped by the gripper fixed to the end or the tool) can carry out displacements referred to as Schoenflies in literature, namely being translationally moved along xyz and rotationally moved about the axis z. Schoenflies displacements mean movements of rigid bodies consisting of a linear movement in a three-dimensional space plus an orientation about an axis with a fixed direction. In robotic handling, this is a movement adapted to operations required to move an object or a tool from one a plane and to move it with a different orientation on another parallel plane.

Because the SCARA manipulator was one of the first manipulators to provide a similar movement, the SCARA type movement is often referred to. Today, numerous robotic manipulators, of which some with a parallel kinetic architecture, are used in the industry for applications ranging from the manufacturing of electronic products to the industry of the transformation and the packaging of food.

This version makes it possible to have a manipulator robot which can carry out pick/place, palettising/depalettising tasks with an effectiveness greater than the SCARA robots on the market.

It is also possible to add three motorised mechanical connections acting as a wrist, at the distal end (20). In this case, the manipulator arm can place an object by controlling the three degrees of freedom in xyz and the three degrees of freedom of orientation.

Other Embodiment Variant

Another embodiment variant relates to a mechanism being distinguished from preceding variants by the fact that the two first proximal bars are removed and that the opening of the pantograph is controlled by controlling the distance between two points of the remaining kinetic chain.

FIGS. 13 and 14 represent a schematic view of the kinetics of the invention.

The pantograph is truncated from the two proximal bars (1, 2). An actuator controlling the distance between the two proximal peaks of the truncated pantograph makes it possible to control its opening.

The geared motor (32) makes it possible to control the orientation of the first intermediate frame (35) by the shaft (31).

A slide connection and a linear motor (24) allow control of the translation in z of the second intermediate frame (23).

The passive pivot articulation (13) of the bar (3) is articulated on the shafts (57) and (58) fixed on a nut (52) translationally constrained by a first shaft (59) and a second mechanical assembly consisting of a threaded shaft with thread to the right (55), a toothed pinion (54) and a threaded shaft with thread to the left (56). The nut (52) slides freely on the shaft (59) while it has an inner threading allowing a screw/nut type connection with the threaded shaft (55) to be made.

The same principle regulates the articulation of the passive connection (11) of the bar (4) on the nut (53).

A geared motor (29) integral with the frame (23) makes it possible to control the rotation of the mechanical assembly (54 to 56) thanks to the toothed pinions (60, 54). The toothed pinion (54) can only be rotationally moved and transmits this rotational movement to the two threaded shafts (55) and (56), which due to their inverted screw thread will move closer or farther away by an identical length, the articulations (11) and (13) of the bars (3) and (4).

The axis of the shaft (31) passes through the pinion (54) in a point which constitutes the middle, referenced B, of the base of the isosceles triangle formed by the projections of the articulations (11 to 13).

The angle between the direction x and the straight line (BA′) is controlled by the rotation of the geared motor (32) while the distance BA′ is controlled by the rotation of the geared motor (29).

1. A robotic system, comprising: an articulated arm having a deformable assembly comprising a plurality of bars connected by parallel pivot axes to form at least one deformable assembly, a distal end of said deformable assembly supporting a mechanical interface, said robotic system further comprising two actuators driving rotation of two bars of said plurality of bars, said robotic system further comprising a third actuator controlling a translational movement of said deformable assembly in a direction parallel to said pivot axes.

2. The robotic system according to claim 1, further comprising a main frame and wherein the two actuators are disposed on said main frame.

3. The robotic system according to claim 1, wherein the third actuator controls the translational movement by an irreversible screw/nut system.

4. The robotic system according to claim 1, wherein each of the bars of the plurality of bars includes an assembly of two profiles connected by a spacer.

5. The robotic system according to claim 4, wherein for each bar of the plurality of bars, the two profiles are surrounded, in a direction parallel to the parallel pivot axes, by two profiles of another bar of the plurality of bars.

6. The robotic system according to claim 1, further comprising a U-shaped main frame having a plurality of lateral branches, each taking up at least some forces of the parallel pivot axes.

7. (canceled)

8. The robotic system according to claim 1, wherein said deformable assembly comprises at least two consecutive deformable quadrilaterals sharing common bars of the plurality of bars.

9. The robotic system according to claim 1, wherein said deformable assembly comprises two deformable diamonds sharing common bars of the plurality of bars, the two deformable diamonds being connected by a central pivot and consisting of six bars of the plurality of bars assembled by pivot connections of an axis perpendicular to a plane defined by said six bars.

10. The robotic system according to claim 1, wherein said deformable assembly consists of an assembly of N deformable diamonds sharing common bars of the plurality of bars, connected by central pivots and 2N+2 bars.

11. The robotic system according to claim 1, wherein the two actuators and the third actuator are situated on a main frame.

12. The robotic system according to claim 1, further comprising at least one intermediate frame and wherein said the two actuators and the third actuator are situated on a main frame.

13. The robotic system according to claim 1, wherein a height of the robotic arm is adjusted by a plate actuated by a threaded rod.

14. The robotic system according to claim 1, wherein a first proximal bar of the plurality of bars is driven by a first actuator of the two actuators by a shaft and a second proximal bar of the plurality of bars is angularly driven by a second actuator of the two actuators by a series of hollow shafts which slide freely against one another.

15. The robotic system according to claim 1, wherein a first proximal bar of the plurality of bars is driven by a first actuator of the two actuators by way of a shaft and a second proximal bar of the plurality of bars is angularly driven by a second actuator of the plurality of actuators by way of a second shaft and a system of sliding at least one of toothed pinions or toothed belts.

16. The robotic system according to claim 1, wherein a first actuator of the two actuators is fixed on the main frame and controls an orientation of an intermediate frame by way of a first shaft, and controls an orientation of a proximal bar of the plurality of bars, wherein a second actuator of the two actuators is fixed on the main frame or on the intermediate frame and controls an orientation of a second bar of the plurality of bars by way of a shaft.

17. The robotic system according to claim 1, wherein a first actuator of the two actuators is fixed on a main frame and controls an orientation of a first intermediate frame, wherein a slide connection placed on the first intermediate frame controls placement along an axis perpendicular to a plane defined by said deformable assembly, wherein a second intermediate frame supports a proximal end of said deformable assembly wherein the third actuator is fixed on the second intermediate frame or on the first intermediate frame or on the main frame and controls an orientation of a first bar of the plurality of bars by way of a shaft, wherein a second bar of the plurality of bars remains fixed with respect to the second intermediate frame.

18. The robotic system according to claim 1, wherein proximal bars of the plurality of bars of said deformable assembly are assembled on an intermediate frame controlled in translation by a slide connection and a first actuator of the two actuators.

19. The robotic system according to claim 1, wherein said deformable assembly is formed of the plurality of bars connected by pivot axes, wherein a relative distance between a plurality of proximal articulations of said deformable assembly is controlled by an actuator of the two actuators, wherein an orientation of said deformable assembly in a plane perpendicular to said pivot axes is dependent on an intermediate frame.

20. The robotic system, according to claim 1, wherein the distal end of said deformable assembly supports a gripping member or a tool, wherein proximal axes of rotation and of the plurality of bars are parallel and are not coincident and wherein angular positions of the plurality of bars are controlled by the two actuators.

21. The robotic system according to claim 1, wherein a distal end of the robotic arm comprises supports a gripping means or a tool.

22. The robotic system according to claim 1, wherein a distal end of the robotic arm comprises a wrist comprising at least one motorised articulation, and supporting a gripping means or a tool.

23. The robotic system according to claim 1, wherein a distal end of the robotic arm comprises a fourth actuator controlling an orientation of an additional arm supporting a mechanical interface.

24. The robotic system according to claim 1, comprising a main frame assembled on a carriage or a mobile robot.

25. The robotic system according to claim 1, comprising a main frame fixed to the ground.
